(19) United States
(12) Patent Application Publication
(10) Pub. No.: US 2014/0270421 A1
(43) Pub. Date: Sep. 18, 2014

(54) MULTI-LAYER BIOMETRIC MATCHING SYSTEM

(71) Applicant: ALLWEB TECHNOLOGIES INC, Bridgewater, NJ (US)

(72) Inventors: Shoab A. Khan, Lahore (PK); Javeria A. Khan, Rawalpindi (PK); Rabia Anwar, Rawalpindi (PK); Sheikh M. Farhan, Rawalpindi (PK)

(21) Appl. No.: 13/840,574

(22) Filed: Mar. 15, 2013

(51) Int. Cl. G06K 9/00

(52) U.S. Cl. CPC G06K 9/001; G06K 9/0008
USPC 382/125

(57) ABSTRACT

The systems and methods of the present invention for multi-layer feature based biometric matching comprise of distributed acquisition sites for acquiring the biometric features and central processing servers, where the biometric matching may be performed. The proposed systems and methods may be run at the central processing servers of any large biometric matching system, and may comprise a plurality of scalable processing layers that coexist to perform high-density matching operations in reduced time. The system for matching biometric features may comprise a user domain, a controller domain, a matching domain, the user domain communicates with the controller domain, and the controller domain communicates with the matching domain.

### FIELD OF THE INVENTION

The present invention relates to systems and methods for multi-layer biometric matching, and more specifically, to feature based biometric matching systems and methods. The systems and methods may comprise of distributed acquisition sites for acquiring the biometric features and central processing servers, where the biometric matching may be performed. The proposed systems and methods may be run at the central processing servers of any large biometric matching system, and may comprise a plurality of scalable processing layers that coexist to perform high-density matching operations in reduced time.

### BACKGROUND OF THE INVENTION

With the rising security concerns and the proliferation of transactions and interactions over the Internet, there is an increasing need for accurate and efficient mechanisms to validate the identity of users. Due to the inimitability of certain human features, biometric-based validation provides an excellent mechanism for identifying any unique user. Biometric based validation uses physical and/or behavioral characteristics of a human being to identify the user. Physiological characteristics are related to the shape of the body, such as, for example fingerprint, face recognition, DNA, hand and palm geometry, iris recognition, which has largely replaced retina, and odor/scent. Behavioral characteristics are related to the behavior of a person, such as, for example typing rhythm, gait, and voice. Biometric based identification provides a high degree of reliability as alteration of these human features is very difficult.

Organizations with large client bases, such as email clients or other web-based services, have historically used password based validation techniques to validate users. This method, although easy to acquire and manage, has major drawbacks. One of which is the ease with which passwords may be misused. Passwords may be easy to crack and the service provider has no way of knowing whether the rightful user is requesting access to its services. Biometric features on the other hand are unique to every human being; such features are difficult to forge or alter. The use of such biometric based identification and validation techniques would ensure that the lawful user receives the services that are being provided.

There are two types of biometric based validation, authentication and identification. Authentication refers to a validation process in which the identity of a person is verified against an available profile. Whereas identification refers to a validation process in which the identity of an individual is verified by comparing it with the profiles of the whole group of enrolled users until a match is found in the system. The former requires a one-to-one matching mechanism whereas the later performs one-to-many matching. These two types of validation may be used for different types of applications and scenarios. In case of biometric authentication, processing large amounts of data is generally not required for every queried data. Hence, such systems may be implemented using a software platform and standard matching algorithms. The one-to-many type of matching requires extensive processing capability and may require large processing time.

Presently biometric matching is generally used for verifying identities of individuals, or in other words authentication. Due to the ease of one-to-one matching, biometric authentication systems have generally been more prevalent. Authentication service applications usually take the low end of the market with small to medium scale systems that provide authentication services to a number of users in terms of one-to-one matching. These systems are found in a number of consumer applications that provide basic security for individuals or organizations. Examples of which are thumb impression devices installed at entry points; which may be used to authenticate employees or to allow only authorized personnel entry. Other examples include biometric authentication services found in handheld devices such as PDA's, laptops etc. These devices may take user fingerprint or facial scans to authenticate a valid user and provide login access instead of incorporating the conventional password scheme. Client authentication is also used in many organizations to ensure lawful service access. For example, some banks request clients to provide finger or palm prints before allowing access to private lockers & vaults. Biometric scanners are now also available in consumer electronic devices such as Flash Drives, music players, smartphones, ATM cards etc; they provide a basic one-to-one matching operation with a stored image to verify a correct user. Such an invention is described in U.S. Patent Publication No. 2008/0069408 filed Sep. 18, 2006, which defines a biometric matching system where acquired biometric images are matched against pre-stored images in a database. An image is acquired through a camera and processed with a match processor and match detector. Computer software informs the user of the results of matching the acquired image with a list of images from the database. This system essentially works one-to-one on a subset of the whole stored database of the images.

Biometric identification is also used in high end systems where individuals have to be identified from a large set of records. These identification systems generally require large complex setups, where conventionally input data may be provided on-site and may not be accessed remotely. While biometric authentication can be used to provide a service to a single user, biometric identification is essentially used by large organizations. These large biometric systems generally have a limit to the amount of data they can process in a given time and such processing times may be quite long. The larger the database of records that need to be searched, the larger and more complex these system become. Furthermore, the size of the database also affects the time required to perform a match. Examples of these identification systems are criminal identification systems used by security agencies. When such systems operate at the national level, the processing time for a single query (in the form of a set of finger or palm prints) takes hours to perform such as the FBI IAFIS system (1 hour and 12 mins). As the need for identification increases, the demand for identification systems which are able to process large amounts of data quickly increases, however, there are no adequate solutions at present.

U.S. Patent Application No. 2004/0059923 filed Sep. 25, 2002; discloses a large scale biometric system that is deployed in Connecticut's DSS Digital Imaging System. This system was designed to prevent people from improperly receiving welfare benefits if applying from more than one name or location. As new applicants are registered, the digital record is matched against an established database in real time. The time this system takes to complete this matching process is claimed to be under 5 minutes. However, the database size or number of records that must be matched are relatively smaller because the number of entries are limited to the total number of welfare applicants in Connecticut.

U.S. Pat. No. 7,298,873 filed Nov. 16, 2004 describes a plurality of biometric clients that capture and send biometric data for matching to biometric matching engines through routers. Each biometric matching engine includes multiple biometric processors. Each biometric processor, however, is adapted to process biometric data of a particular type, for example, facial, retina, or fingerprint etc. These biometric processors also include third party SDKs that compare biometric templates and generate matching scores. Thus, this reference focuses on separate processor for each type of biometric data and discloses a software based approach for the central matching processor implementation.

Thus, there is a need for a method and apparatus for a multi-layer scalable processing architecture for feature based biometric matching. Various embodiments of the present invention, but not necessarily all, address this need and provide a method and apparatus for a multi-layer scalable processing architecture for feature based biometric matching. The present invention achieves processing speed greater than that disclosed by any existing disclosure by proposing a multi-layer scalable processing hardware-based architecture for a feature based matching machine that may even be implemented on a Single Silicon Chip. A silicon chip is a small chip made up of silicon; and it contains millions of electronic components that can be used to build electronic circuits. Silicon chips are small, have low designing cost and provide high speed and low power consumption. The present invention can easily be placed on such silicon chips where a single silicon chip provide the vast speed. Thus, various embodiments of the present invention may be implemented on FPGAs and CPUs. FPGA is a field programmable gate array, i.e., an integrated circuit capable of being designed by the customer, while GPU is a graphic processing unit. Moreover, various embodiments of the present invention may be used for any feature based biometric application e.g. face recognition, iris recognition, palm recognition, fingerprint recognition, etc. In addition, various embodiments of the present invention may be capable of handling and processing such large numbers of matching requests, and still be able to adapt to changes in the biometric feature that is matched.

### SUMMARY OF THE INVENTION

Responsive to the foregoing challenges, Applicant has developed an innovative apparatus for matching biometric features, the apparatus comprising: a user domain; a controller domain; a matching domain; the user domain communicates with the controller domain; and the controller domain communicates with the matching domain.

Applicant has also developed an innovative apparatus for matching biometric features, the apparatus comprising: a user domain; a controller domain; the controller domain comprises a receiver that is adapted to receive the biometric features, a template distributor that is adapted to make copies of the biometric features and to distribute the copies, the receiver communicates with the template distributor, a state machine that is adapted to control the flow of data in and out of the matching domain, the template distributor communicates with the state machine, a data collector that is adapted to collect the collect the data coming from the matching domain, the state machine communicates with the data collector, a score generator, the data collector communicates with the score generator, and a dispatcher that is adapted to communicate with the user domain. a matching domain; the matching domain comprises one or more matching layers; the user domain communicates with the controller domain; and the controller domain communicates with the matching domain.

Applicant has also developed a computer implemented method for matching biometric features of a user, comprising the steps of: receiving input template from the user and query templates from a central database; making copies of the input template and query templates; distributing copies of the input template and query templates to feature filtration layers on a single system on chip; analyzing the input template and query templates at the feature filtration layers; collecting results of the filtration performed at the feature filtration layers; generating a matching score based on the collected results; and providing the matching score to the user.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic view of the high-density biometric identification system, which discloses that the gatekeepers acquire input data from distributed acquisition sites and send it to the central processing servers through request handlers. The central processing server area comprises of matching servers and database engines.

FIG. 2 is a schematic view of the overall matching system with three different stages where the inner most stage shows the distribution of matching process into 3 parallel matching layers based on the feature type.

FIG. 3 is a schematic view of the further distribution of each layer into 3 processing parts where each part is meant to perform tasks based on the processing type, pre-processing, filtration and the post-processing.

FIG. 4 is a schematic view of the components of the matching controller and the data flow between them.

FIG. 5 is a schematic view of the data flow diagram of the matching controller showing the tasks for different components and how the data is transferred from user application to the matching interface and vice versa.

FIG. 6 is a schematic view that depicts the scalability of the system within each layer.

It will be appreciated that for purposes of clarity and where deemed appropriate, reference numerals have often been repeated in the figures to indicate corresponding features, and that the various elements in the drawings have not necessarily been drawn to scale in order to better show the features of the invention. The drawings are exemplary only, and should not be construed as limiting the invention.

### DETAILED DESCRIPTION OF EMBODIMENTS OF THE INVENTION

As embodied herein, the present invention relates to a system and method for multi-layer scalable processing architecture for feature based biometric matching. A biometric feature is an attribute that holds and represent the information of any biometric sample, i.e., a biometric feature is a distinctive attribute of a biometric sample. The system and method of the present invention may separate biometric features based on their type and may apply filters on the features. The system and method of the present invention may be mapped onto a scalable and parallel processing architecture to achieve high matching speeds. The process incorporates a layered approach with all layers may be data independent and the layers may include further sub-layers, which are scalable in nature. The sub-layers may also be adjusted according to availability of resources and/or computation requirements. This layered approach permits easy processing of large amounts of data in relatively short amounts of time. This may be accomplished by breaking the matching functionality into multiple independent sub-functions based on the feature type and each sub-function may be mapped on a separate layer. Furthermore, the layered architecture may be designed in such a way that if some future enhancement or functionality is needed, then it can be added in the form of a new sub-layer without disturbing the existing functionalities.

Reference will now be made in detail to embodiments of the systems and methods of the present invention, examples of which are illustrated in the accompanying drawings. As embodied herein, embodiments of the present invention include systems and methods for multi-layer scalable processing architecture for feature based biometric matching. FIG. 1 schematically illustrates a general distributed matching system, parts of which are known in the prior art. As shown in FIG. 1, the distributed matching system may receive query data from a number of distributed gatekeeper sites 100 that may be deployed globally. The query data may be the biometric feature or the biometric information of a person who needs to be identified by the system. The distributed gatekeeper sites 100 may be device responsible for receiving query data from different sources and directing them along their correct paths. The distributed gatekeeper sites 100 may be dedicated hardware machines running specific software routines or simply software applications embedded at the user end to perform the required functions.

As shown in FIG. 1, the distributed gatekeeper sites 100 may be connected via wired or wireless connection to one or more computers (including one or more of processing, memory devices, and or high speed RAMs) that collectively provide through hardware and/or software implementation the request handlers 1. The query data received at the distributed gatekeeper sites 100 may be sent to the request handlers 1, which manage the requests, prioritize them and send them to the central processing system 2 for processing.

The central processing system 2 may consists of matching servers 3 and central databases 5. The central database 5 may have a dedicated database assigned to it and may comprise one or more computers (including one or more of processing, memory devices, and or high speed RAMs) that collectively provide through hardware and/or software implementation the central database 5. As shown in FIG. 1, the central databases 5 may be connected via wired or wireless connection to one or more computers (including one or more of processing, memory devices, and or high speed RAMs) that collectively provide through hardware and/or software implementation the matching servers 3. In an exemplary embodiment, the matching server 3 may be a machine that may comprise several matching engines 4 that are designed to perform high speed matching. The matching engines 4 may be single system on chip (SoC), such as, for example, FPGA boards, GPUs, or any other silicon based chip that may perform high speed matching and be scalable. As shown in FIG. 1, each matching engine 4 may be adapted to accept incoming query data and the data from the central database 5 and to produce result 11. The central databases 5 may house all of the registered biometric records, which may be used as input data during the matching process. The central database 5 may interact with one or more matching servers 3, likewise, the matching servers 3 may interact with one or more central database 5.

An exemplary embodiment of the matching engine 4 is depicted in FIG. 2. As shown in FIG. 2, the matching engine 4 may be divided into three portions or domains. These three domains may be the user application domain 8, the controller domain 9, and the matching interface 10. The outer most layer may be the application domain or user domain 8 where the input data may be acquired either from the user or from the database. The middle layer 9 may be the controller domain, which may control the input and output data flow as well as the data management and distribution. The inner most layer 10 may be the matching interface where the actual matching processors reside.

The user domain 8 may serve as the interface between the user and the system. The user domain 8 may acquire the query data 7 and send it to the controller domain 9 in the form of query template 7. A template may be a collection of biometric data or data used to uniquely identify people. Query templates may originate from the end user while input templates may be those templates that already reside in the system database. Query template may be arranged in a form that is useful for the matching process. For example, in case of the biometric feature being a fingerprint, query template may be the set of basic features of a fingerprint minutia, fingerprint class and its singular points. A minutia may be a point in fingerprint where a fingerprint ridge line either ends or bifurcates into two branches. The salient features of this minutia point may its pixel location on the x-y plane known as x, y-coordinates, the orientation of the preceding ridge known as minutia angle, and the minutia type meaning whether it is an end point or a bifurcation. The fingerprint images may be divided into five classes based on their ridge pattern and this fingerprint class may be stored in a template for the sake of identification. The singular points of a fingerprint are those points where the ridges makes a pattern as if they are converging at some point known as core point, or as if they are diverging from a point known as delta point.

Thus, query template 7 may consist of basic features, class, and singular points of user's fingerprint in a particular sequence. This query template 7 may be passed from user domain 8 to the controller domain 9. Along with the query template 7, the user domain 8 may also fetch input template 6 stored in a input database 5 and send it to the matching domain 10. Input template 6 is a set of features that may belong to some other user and that has previously been stored in central database 5. The user domain 8 may also control and manage the query template 7 and input templates 6 data flow according to the speed of matching system and its rate of output to input flow. As shown in FIG. 2, the output of the matching engine 4 is a matching score 11. The matching score 11 may be passed from the controller domain 9 to the user domain 8. The matching score may or may not be stored into an output database, which may be a part of central database 5.

The controller domain 9 may comprise of the main controller that may be responsible for handling data flows and the matching layers may also reside in the central matching domain 10. As shown in FIG. 4, the controller domain 9 may consist of a receiver 27 that may receive the query template 7 and input templates 6 and may pass it on to the template distributor 28. The template distributor 28 may make duplicate copies of templates and distribute it amongst the different layers. The state machine 29 may control the flow of data in and out of the matching interface 10 and may interact with all the components of controller domain 9 and matching domain 10. The template distributor 28 may wait for the signal from the state machine 29 and distributes the query template 7 and input templates 6 into the matching layers 12, 13, and 14 of matching domain 10. The data collector 30 may collect the resultant data coming from the matching layers. As shown in FIG. 2, the matching layers may comprise of the primary feature filtration layer 12, secondary feature filtration layer 13, and global feature filtration layer 14.

When the set of scores 15, 16, and 17 from matching layers 12, 13, and 14 respectively is received by the data collector 30, the state machine 29 may allow the score generator 31 to combine the scores and compute a final decision either in the form of a score or in the form of a matching or non-matching signal, which is shown as matching score 11 in FIG. 4. The dispatcher 32 may then provide the final score 11 to the user domain 8. The data collector 30 may be a built-in memory interface on an FPGA which is used to receives the results produced by matching interface 10. The state machine 29 may be combination of memory registers that have the capability of managing outputs using incoming and previously stored inputs. As shown in FIG. 4, the score generator 11 may be a device which receives different resultant data from a single matching process and combine them to generate a single final score 11.

In an exemplary embodiment, the data flow between the components 27, 28, 29, 30, 31 and 32 of the controller domain 9 is shown in FIG. 5. The receiver 27 may receive two types of data simultaneously, input template 6 and query templates 7. On receiving these templates, the receiver 17 may pass the input template 6 and query templates 7 onto the template distributor 28. This template distributor 28 may perform two tasks. First, it make appropriate number of copies of both input template 6 and query templates 7. Second, when copies of the input template 6 and query templates 7 are ready, the template distributor 28 may distribute them to the parallel matching layers 12, 13 and 14 through the state machine 29. The state machine 29 may then wait for the matching results to be provided by the matching layers. The state machine 29 may remain in the wait state until it provides the result of the match to the data collector 30. The data collector 30 may pass the match results onto the score generator 31, where the final score 11 may be produced. The score generator may pass the final score 11 to the dispatcher 32, which is the interface between the controller domain 9 and the user domain 8. As shown in FIG. 4, the dispatcher 32 may provide the final score 11 to the user domain 8.

As shown in FIG. 2, the matching interface 10 may break the whole matching process into three different layers based on the type of feature received. Among any feature based matching, there are three types of features; the primary features, consisting of basic data characteristics; the secondary features, derived from the primary features using standard mathematical techniques; and the global features, which depict the global data characteristics. Global features of a biometric sample are those features which reveal the overall characteristics of the sample. Such features do not provide the detailed information but just the overall picture of the sample. For example in case of a fingerprint, fingerprint class is the global feature because it just describes the overall fingerprint pattern, not the minutia details. The matching interface 10 may process all three types of data independently and in parallel. When three copies of the query template 7 and input template 6 arrives at the matching interface 10, a copy of the query template 7 and input template 6 each are passed simultaneously into the three different layers 12, 13, and 14 where the layers process the data in parallel. The layers 12, 13, and 14 may each filter the data and may select a small amount of data from a big data set based on the requirements of the particular filtration layer. Filtration reduces processing time when there is a large amount of data waiting to be processed and due to filtration only processing of the filtered data may be carried out. The three layers 12, 13, and 14 may be named after their feature types for which they are working, i.e., the primary feature filtration 12, the secondary feature filtration 13, and the global feature filtration 14.

As shown in FIG. 3, each matching layer may be further divided into three types of units, known as pre-processing units 18, 21, and 24, the filtration units 19, 22, and 25 and the post-processing units 20, 23, and 26. Each of these nine units may have their own dedicated tasks. For example, the pre-processing unit 18, 21, and 24 may convert the data in a desirable form for the filtration units 19, 22, and 25. The pre-processing unit 18 may not perform any pre-processing, but may function as the feature distributor in primary feature filtration layer 12 because the data in query template 7 and input templates 6 itself is the set of primary features. But, for secondary and global features, the data in query template 7 and input templates 6 it may get pre-processed by the pre-processing units 21 and 24. The pre-processing units 21 and 24 may then pass on the data in query template 7 and input templates 6 to the filtration units 22 and 25. The post-processing units 20, 23, and 26 for all the layers may get the filtered data from their respective filtration units 19, 22, and 25 and may compute the set of scores 15, 16, and 17 to send out to the data collector 30 in the controller domain 9.

The filtration unit 19, 22, and 25 may consist of a number of filters where each filter may be designed to select only the relevant feature set and then may determine the authenticity of the selected feature set. Based on the different feature sets in a single category, the matching layers can further be divided into independent parallel layers where each unique feature is processed in a single layer. For example, in a fingerprint template, there are three types of primary features against each minutia point, x, y-coordinates, angle and type. Thus, as shown in FIG. 3, the primary feature filtration layer 12 may comprise of three different sub-layers: the distance filter layer 33, the angle filter layer 34, and the type filter layer 35 that processes each type of primary feature. Each filtration sub-layer may processe its designated feature in parallel and generates a score. The resulting scores of all the three filters may then be sent out to the score generator 31 through data collector 30 where the final score 11 may be computed out. Thus, by breaking down the matching process into such steps which are independent of each other and can be performed in parallel the overall design can exploit maximum parallelism when mapped on architecture capable of allowing parallelism, e.g., FPGAs, GPUs, etc. Accordingly, by performing multi-matching tasks in parallel a lot of processing time may be reduced and the system speed may be enhanced.

The matching interface 10 may be mapped onto such an architecture where the scalability within a single process can be achieved. For example, if this matching is performed on an FPGA device, then as shown in FIG. 6, any number of sub-layers of the matching layers can be instantiated based on the resources availability. For example, to double the capability of a sub-layer, we may not need to double the capability of the whole layer, but we may need to only double the filters placed in the second portion of the sub-layer. In an exemplary embodiment, the scalability of the system is further illustrated in FIG. 6. If the primary feature filtration layer has three sub-layers (distance filter, angle filter, and type filter) and the angle and type filters produce results three times faster than distance filter, then three distance filters may be instantiated instead of one. Thus, the scalability within the sub-layers may be achieved and the processing bottleneck may be overcome because all the sub-layers will produce results simultaneously. In addition, optimum resources may be used to overcome the processing bottleneck because the entire sub-layers may not be duplicated, but only the filters within the sub-layers may be duplicated.

The matching interface 10 may be highly configurable as all its layers and sub-layers may be data independent, which means they are loosely coupled. For example, if a specific layer in matching interface 10 is not required to perform its filtration process, then the state controlling that specific layer can be removed from the controller without any alteration to the rest of the system. If during some future enhancements, some other feature needs to be incorporated in the matching process, then the new feature should be processed in a separate sub-layer without disturbing the other layers. The only change in the system would be at controller domain 9. For example if a matching application needs to examine some features not shown in FIG. 3, the new feature should be added to the presented solution by using the layered framework. The pre-processor, filter and the post-processor for that specific feature may be designed and placed in parallel with the other sub-layers, and the state machine 29 of the controller domain may be altered to start passing the data to and from that sub-layer. The score generator 31 may also be updated so that the result 11 is produced by utilizing the additional resultant data coming from the post-processor of the newly added sub-layer.

Operation of an embodiment of the present invention will now be described. The proposed system architecture can be used in any kind of biometric based matching system. However since fingerprint matching has been around the longest and is still the most common, it is used as an example. Human fingerprints are made up of a series of unique points on the surface of the finger called ridges, furrows, and minutiae. The uniqueness of a fingerprint may be determined by the pattern of ridges and furrows as well as the minutiae points. The matching of fingerprints may be carried out by comparing the number, location, and other such characteristics of these features from both sets fingerprints. A matching system would first extract these features from fingerprints and then compare them.

As shown in FIG. 1, query fingerprint feature data, query template 7, may received at distributed gatekeeper sites 100. This data may be routed to the central processing system 2 through intermediate request handlers 1. The central processing system 2 may contain a database 5 of fingerprint records that need to be matched against each incoming query template 7. All the matching servers 3 may receive the same input templates 6 and the unique query template 7. Thus, the distributed processing at multiple matching servers 3 may speed up the matching process.

As shown in FIG. 4, for a single matching engine 4, the query template 7 and input data 6 may enter the controller domain 9 through receiver 27 from the user domain 8. A standard fingerprint template may consist of the fingerprint class, the core points, the delta points and the set of primary features of M number of minutiae, where M can be any natural number starting from 0. Each primary feature set may have three types of features: the x,y-coordinates of the minutia point, the minutia angle θ and the minutiae type t and may be represented as {x,y,θ,t}. The receiver 27 may pass the query template 7 and the input templates 6 on to the template distributor 28 where the three copies of each may be prepared. These three copies may then be broadcasted into the matching interface 10 where each can arrive at a separate matching layer. State machine 29 may generate a start signal for the three layers 12, 13, and 14 to start their processing simultaneously.

As shown in FIG. 3, in the primary feature filtration layer 12, the query template 7 and input templates 6 first reach into the pre-processor 18. The pre-processor 18 may extract the M primary feature sets from the full template and may separate them from each other for the separate usage in the sub-layers. Relative distances from x-y-coordinates for all M minutiae may be calculated and passed to the distance filter 33. Similarly, the relative angle differences and the type differences for all M minutiae may be computed and sent to the angle filter 34 and type filter 35, respectively. For primary feature filtration layer, the query template and input templates may not be processed together, they may be processed separately at pre-processing and filtration stage. After the filtration process is done, the filtered data for query template and input templates may be combined and may be post-processed altogether. Each primary filtration sub-layer 33, 34, and 35 may produce a result, which may be sent to the data collector 30 of controller domain 9 through state machine 29, as shown in FIG. 4.

In secondary feature filtration layer 13 and global feature filtration layer 14, the query and input templates are processed simultaneously at all the stages, i.e., pre-processing 21 and 24, filter 22 and 25 and post-processor 13 and 26. Since secondary feature filtration layer 13 has two sub-layers 36 and 40, so the number of results produced at the end of this layer are 2. As shown in FIG. 4, these results are sent to data collector 30 of controller domain 9 through state machine 29.

The global feature filtration layer 14 may separate out the global features of the fingerprint template. The core point, the delta point and global quadrants of both query and input templates may be separated and may be sent to their sub-layered filters 38, 39, and 40 where the correspondence between these values may be verified and three decisions may be computed, one by each sub-layer. These three decisions may be further manipulated by post-processor 26 to make a final yes or no decision which may be termed as the global authentication score 17 and may be sent to the score generator. As shown in FIG. 4, these results are sent to data collector 30 of controller domain 9 through state machine 29.

When the data collector 30 has received all relevant scores 15, 16, 17 from the filtration layers, the state machine 29 may inform the score generator 31 to collect those set of score values 15, 16, 17 and figure out a final score 11 which may be send out to the user domain 8 through the dispatcher 32. The final score 11 may either get stored in some database or may be passed onto the user as required.

It will be apparent to those skilled in the art that variations and modifications of the present invention can be made without departing from the scope or spirit of the invention. For example, conventional computer system can be instead of a single system on chip (SoC) without departing from the invention's intended scope.

What is claimed is:

1. An apparatus for matching biometric features, the apparatus comprising:
a user domain;
a controller domain;
a matching domain;
the user domain communicates with the controller domain; and
the controller domain communicates with the matching domain.

2. The apparatus of claim 1, wherein the user domain, controller domain and the matching domain are disposed on a single system on chip.

3. The apparatus of claim 2, wherein the single system on chip comprises a FPGA.

4. The apparatus of claim 2, wherein the single system on chip comprises a GPU.

5. The apparatus of claim 1, wherein the controller domain further comprises:
a receiver that is adapted to receive the biometric features;
a template distributor that is adapted to make copies of the biometric features and to distribute the copies;
the receiver communicates with the template distributor;
a state machine that is adapted to control the flow of data in and out of the matching domain;
the template distributor communicates with the state machine;
a data collector that is adapted to collect the collect the data coming from the matching domain;
the state machine communicates with the data collector;
a score generator;
the data collector communicates with the score generator; and
a dispatcher that is adapted to communicate with the user domain.

6. The apparatus of claim 5, wherein the biometric features received by the receiver comprises query template and input templates.

7. The apparatus of claim 1, wherein matching domain comprises a one or more matching layers and the number of matching layers depends on the biometric features.

8. The apparatus of claim 7, wherein the matching layers comprise primary feature filtration layer, secondary feature filtration layer and global feature filtration layer.

9. The apparatus of claim 8, wherein the primary feature filtration layer comprises distance filter layer, angle filter layer and type filter layer.

10. The apparatus of claim 8, wherein the secondary feature filtration layer comprises quadrant filter layer and cost filter layer.

11. The apparatus of claim 8, wherein the global feature filtration layer comprises global quadrant filter layer, core point filter layer and cost filter layer.

12. An apparatus for matching biometric features, the apparatus comprising:
a user domain;
a controller domain;
the controller domain comprises a receiver that is adapted to receive the biometric features, a template distributor that is adapted to make copies of the biometric features and to distribute the copies, the receiver communicates with the template distributor, a state machine that is adapted to control the flow of data in and out of the matching domain, the template distributor communicates with the state machine, a data collector that is adapted to collect the collect the data coming from the matching domain, the state machine communicates with the data collector, a score generator, the data collector communicates with the score generator, and a dispatcher that is adapted to communicate with the user domain.
a matching domain;
the matching domain comprises one or more matching layers;
the user domain communicates with the controller domain; and
the controller domain communicates with the matching domain.

13. The apparatus of claim 12, wherein the matching layer comprises primary feature filtration layer, secondary feature filtration layer and global feature filtration layer.

14. A computer implemented method for matching biometric features of a user, comprising the steps of:
receiving input template from the user and query templates from a central database;
making copies of the input template and query templates;
distributing copies of the input template and query templates to feature filtration layers on a single system on chip;
analyzing the input template and query templates at the feature filtration layers;
collecting results of the filtration performed at the feature filtration layers;
generating a matching score based on the collected results; and
providing the matching score to the user.

15. The method of claim 14, wherein the method for matching biometric features is performed on a single system on chip.

16. The method of claim 15, wherein the single system on chip comprises a FPGA.

17. The method of claim 15, wherein the single system on chip comprises a GPU.

18. The method of claim 14, wherein the feature filtration layers comprise primary feature filtration layer, secondary feature filtration layer and global feature filtration layer.
